(19) United States
(12) Patent Application Publication
(10) Pub. No.: US 2007/0277203 A1
(43) Pub. Date: Nov. 29, 2007

(54) Apparatus and method for receiving digital multimedia broadcast in electronic device

(75) Inventor: Sung-Kwon Jung, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/803,243

(22) Filed: May 14, 2007

(30) Foreign Application Priority Data
May 25, 2006 (KR) 10-2006-0047247

(51) Int. Cl. H04N 7/16; H04H 9/00; H04N 5/445; G06F 13/00; G06F 3/00

(52) U.S. Cl. 725/46; 725/9; 725/62

(57) ABSTRACT

An apparatus and method for receiving a multimedia broadcast. The method includes determining selected channel and a current time when a broadcast viewing/listening event occurs, determining output setting of a media corresponding to the selected channel and the current time, playing back the multimedia broadcast according to the determined output settings. Accordingly, optimized output settings for each type of media are automatically adjusted to play back the media, even when a user does not manually adjust the playback output settings.

### PRIORITY

This application claims priority under 35 U.S.C. §119 to an application entitled “APPARATUS AND METHOD FOR RECEIVING DIGITAL MULTIMEDIA BROADCAST IN ELECTRONIC DEVICE” filed in the Korean Intellectual Property Office on May 25, 2006 and allocated Serial No. 2006-47247, the contents of which are incorporated herein by reference.

### BACKGROUND OF THE INVENTION

1. Field of the Invention

The present invention relates generally to an electronic device such as portable communication terminal for receiving digital multimedia broadcasting, and more particularly, to an apparatus and method for setting the output settings of a broadcast in the apparatus according to the type of media, and playing back the media.

2. Description of the Related Art

Digital Multimedia Broadcasting (DMB) is an all-encompassing term used to describe state-of-the-art radio and TV broadcasting using satellite, terrestrial, and sky wave media, as well as the transmitting of mobile communication data. As “digital audio broadcasting” technically merged with “digital video broadcasting”, DMB is now a commonly-used term to describe these types of broadcasting.

Currently, electronic devices such as portable communication terminals that receive digital multimedia broadcasts, output the DMB signals according to their output settings for sound and image signals (e.g., resolution, brightness, volume, and sound) in the same image and sound output format, regardless of the type of multimedia. Therefore, when digital multimedia broadcasting is received through an electronic device according to the related art, a user must manually adjust the resolutions, brightness, volume, sound, etc. according to the type of media and the user's personal preferences to enjoy the broadcast at its full potential.

As described above, when an electronic device plays back broadcasts under the same output settings, because the characteristics of each type of media are not fully exploited during playback, a user cannot fully experience the broadcast at its full potential. When the user must manually enter output settings in accordance with each type of media, the user is inconvenienced by having to enter different settings for every change in the type of media received.

### SUMMARY OF THE INVENTION

An object of the present invention is to substantially solve at least the above problems and/or disadvantages and to provide at least the advantages below. Accordingly, an object of the present invention is to provide an apparatus and method for receiving digital multimedia broadcasting in an electronic device.

Another object of the present invention is to provide an apparatus and method for selecting playback settings based on the type of media received by an electronic device, and playing back the media according to the settings.

A further object of the present invention is to provide an apparatus and method that use time and channel broadcast data during playback of digital multimedia broadcasts in an electronic device to automatically change playback settings according to the type of media played back.

According to one aspect of the present invention, there is provided a method of receiving a multimedia broadcast in an electronic device, including determining a selected channel and a current time when a broadcast viewing/listening event occurs, determining an output setting of a media corresponding to the channel and the current time and playing back the media according to the determined output settings.

According to another aspect of the present invention, there is provided an apparatus for receiving a digital multimedia broadcast in an electronic device, including a storage area for storing respective output settings for a plurality of media by time and by channel a controller for determining a selected channel and a current time and reading output settings of a relevant media from the storage area when a broadcast viewing/listening event occurs an output setter for setting playback output settings according to the read output settings and an output for playing back a received media according to the set playback output settings.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a system selecting playback settings according to the type of media to be played back, according to the present invention;

FIG. 2 is a block diagram illustrating the components of an electronic device according to the present invention;

FIG. 3 is a flowchart illustrating a process for obtaining playback data according to the type of media played back by an electronic device according to the present invention;

FIG. 4 is a flowchart illustrating a process for selecting output settings according to the type of media played back by an electronic device, and playing back the media; and

FIG. 5 is a table illustrating broadcast data arranged by time obtained by an electronic device from a broadcasting server, according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Described hereinafter are an apparatus and method that use time and channel broadcast data during playback of digital multimedia broadcasts in an electronic device to automatically change playback settings according to the type of media played back.

The electronic devices to be described below include all types of electronic devices capable of receiving digital multimedia broadcasting.

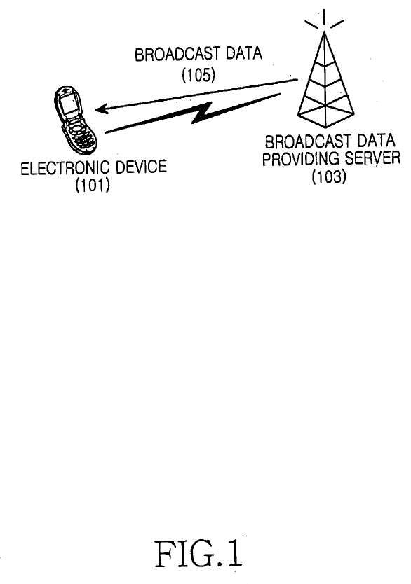

FIG. 1 is a diagram illustrating a system that selects playback settings according to the type of media to be played back, according to the present invention. Here, the system includes an electronic device 101 and a broadcast data providing server 103.

Referring to FIG. 1, the electronic device 101 is capable of receiving DMB signals. The electronic device 101 enters different output settings according to different types of media, and requests broadcast data 105 from the broadcast data providing server 103 (that is, the type of media that is broadcast by time and by channel and the output settings suitable for each type of media) when an event for playing back a broadcast occurs. Next, the broadcast data 105 is received from the broadcast data providing server 103, the output settings for each type of media are analyzed to adjust the output settings in accordance with the analyzed data and the media selected by a user, and the selected media is played back. Here, the type of media may be categorized into categories such as news, movies, broadcasts, music broadcasts, dramas, etc., and the playback data for each category of media may include data with output settings for sound, volume, brightness, resolution, etc., recommended by each media.

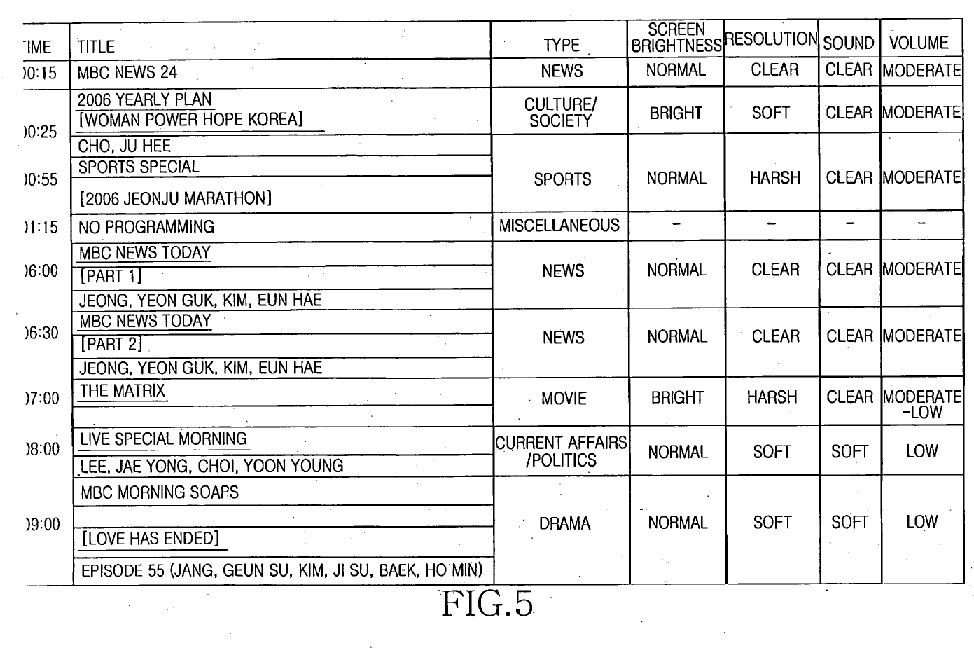

The broadcast data providing server 103 stores by time and by channel data (for example, the title, type, start time, end time, and output settings of each media, by time and by channel). In other words, data on each media that is broadcast at a specific time and on a specific channel, and data on the output settings suitable for each media are stored. Accordingly, when the electronic device 101 requests broadcast data to be provided from the broadcast data providing server 103, the latter transmits the stored data to the electronic device 101. The output settings suitable for each of the media may be output settings that are optimized to utilize the characteristics of the media when playing the media back to a user. Also, the output settings for each broadcast media, as shown in FIG. 5, may store either a single output setting that can be applied equally to all electronic devices for each media, or may store output settings customized for different models or types of electronic devices.

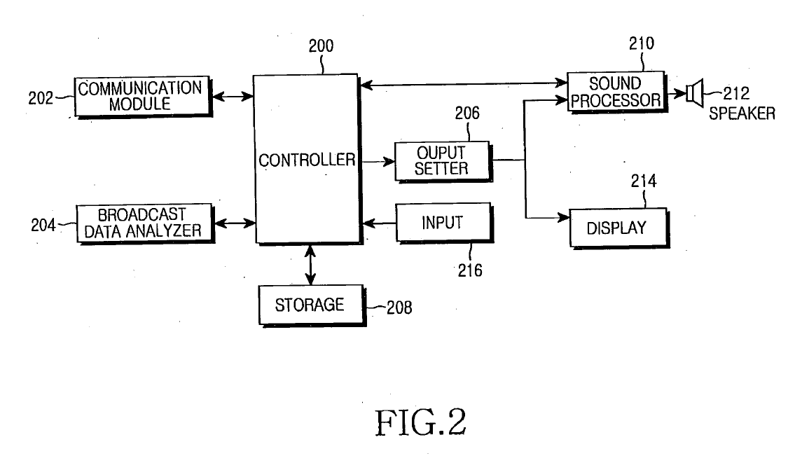

FIG. 2 is a block diagram illustrating the components of an electronic device according to the present invention. Here, the electronic device includes a controller 200, a communication module 202, a broadcast data analyzer 204, an output setter 206, a storage area 208, a sound processor 210, a speaker 212, a display 214, and an input 216.

Referring to FIG. 2, the controller 200 first performs processing and controlling of multimedia broadcasts and data transmission. When an event for obtaining broadcast data occurs, the broadcast data providing server 103 of the present invention controls the function of requesting the provision of the broadcast data, and broadcast data from the broadcast data providing server 103 is provided to the broadcast data analyzer 204. The DMB sound signal received through the communication module 202 is output through the sound processor 210, and a picture signal is output on the display 214. When an event for viewing/listening to a broadcast according to the broadcast data occurs, the analysis results of the output setting data for the relevant media stored in the storage area 208 is read and provided to the output setter 206.

The communication module 202 receives the DMB signal to provide to the controller 200. The communication module 202 according to the present invention encodes a broadcast data provision request signal input from the controller 200, and transmits the signal through wireless communication to the broadcast data providing server 103. The broadcast data signal received from the broadcast data providing server 103 is decoded by the communication module 202 and thereafter transmitted to the controller 200.

The broadcast data analyzer 204 analyzes the broadcast setting data input from the controller 200 and provides the analyzed results to the controller 200. In other words, when the broadcast data from the controller 200 is input, the type of media broadcast is checked (i.e., determined) according to time and channel of broadcast, and preset data for output settings optimized for each type of media (that is, data corresponding to sound, volume, brightness, resolution, etc.) is checked (i.e., determined), and the checked results are provided to the controller 200. For example, with reference to FIGS. 1-2 and 5, if broadcast data by time in channel A is obtained from the broadcast data providing server 103 of the electronic device, the broadcast data analyzer 204 checks that the ‘MBC News 24’ broadcast at 00.25 is a news program, and checks the output settings for a news program that has a normal screen brightness, a clear resolution, a clear sound, and a moderate volume, and provides these settings to the controller 200.

When an event for viewing/listening to a broadcast according to the broadcast data occurs, the output setter 206 receives an input of output setting data from the controller 200 on the media currently being broadcast, sets the brightness and resolution of the display 214 according to the output setting data, and sets the volume and sound for the speaker 212 (through which the sound is output).

The storage 208 stores the types of each broadcast media divided by time and by channel by the broadcast data analyzer 204, and data on appropriate output settings for each type of media.

The sound processor 210 can include a coder-decoder (CODEC), and outputs sound signals through the speaker 212 connected thereto. For example, the sound processor 210 converts a digital sound signal provided by the controller 200 to an analog sound signal to be output by the speaker 212. The speaker 212 according to the present invention outputs the analog sound signal at the volume and sound settings corresponding to those set in the output setter 206.

The display 214 displays selection data that arises from the operation of the mobile communication terminal, and a limited number of characters. The display 214 of the present invention can display an image signal input by the controller 200 at the brightness and resolution settings corresponding to those set in the output setter 206.

The input 216 can include touch screen and/or a key entry devices such as a keyboard (KB) including a plurality of function keys for providing the controller with data corresponding to each key input by a user.

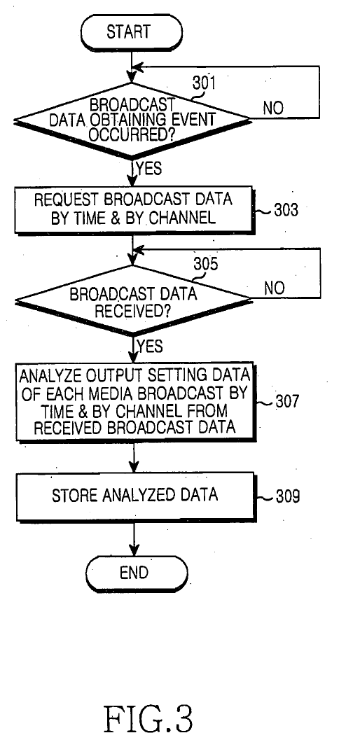

FIG. 3 is a flowchart illustrating a process for obtaining playback data according to the type of media played back by an electronic device according to the present invention.

Referring to FIG. 3, first, it is checked (i.e., determined) in step 301 whether an event for obtaining broadcast data has occurred. Here, an event for obtaining broadcast data may occur when a menu selection for obtaining the broadcast data or a menu selection for viewing/listening to a broadcast according to broadcast output settings is made (for example, by the user), or may occur regularly at predetermined time intervals according to a user's settings. When it is determined that an event for obtaining broadcast data has occurred, the electronic device requests that the broadcast data providing server provide it with respective media broadcast data by time and by channel in step 303.

Next, the electronic device determines whether the requested broadcast data is received from the broadcast data providing server in step 305. When it is determined that the broadcast data is received, the electronic device analyzes the received broadcast data, and checks appropriate broadcast output settings for each media broadcast by time and by channel in step 307. For example, the electronic device may check that the type of media that Woman Power Hope Korea (broadcast at 00:25 on channel A obtained by the broadcast data providing server 103, as shown in FIG. 5) is of a ‘culture/society’ media type, and checks that the output settings corresponding to the culture/society media/type are implemented using a bright screen, a soft resolution, a clear sound, and a moderate volume as shown in FIG. 5.

Then, the electronic device stores each media type checked by time and by channel and the broadcast output settings for each media in the storage area 208, and ends the algorithm of the present invention in step 309.

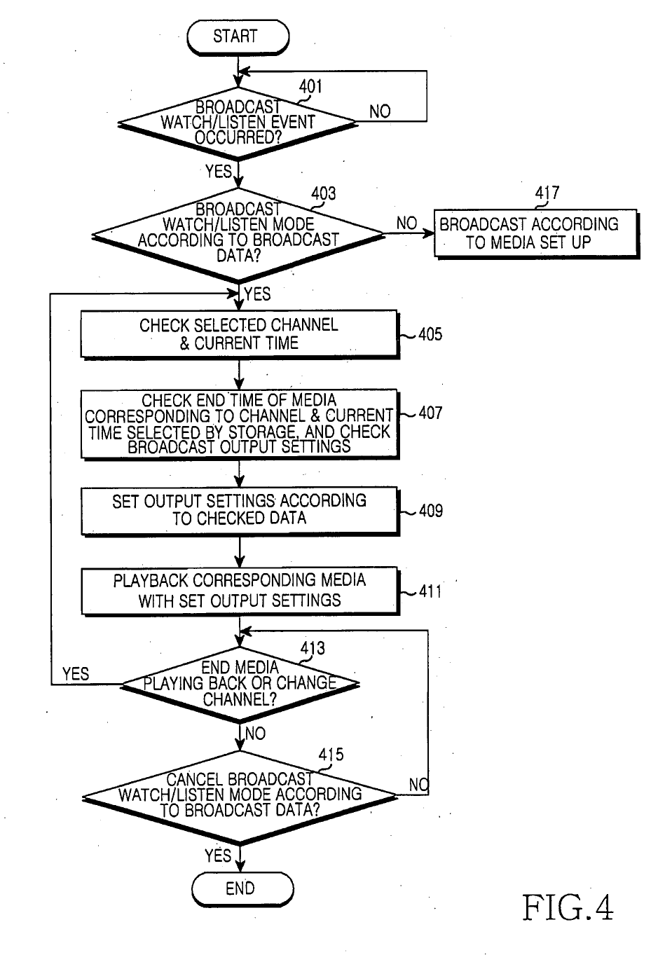

FIG. 4 is a flowchart illustrating a process for selecting output settings according to the type of media played back by an electronic device, and playing back the media.

Referring to FIG. 4, the electronic device determining in step 401, whether a broadcast view/listen event has occurred, on account of a user. When it is determined that a broadcast view/listen event has occurred, the electronic device determines whether a mode for viewing/listening by varying the broadcast output settings according to the type of broadcast media has been set in step 403. If the mode for viewing/listening by altering the broadcast output settings according to the type of broadcast media has not been set, the electronic device does not alter the broadcast output settings and outputs the multimedia broadcast signal received from the communication module 202 through the speaker 212 and display 214 according to the previously set output settings in step 417.

On the other hand, if, in step 403, it is determined that a mode for viewing/listening by varying the broadcast output settings according to the type of broadcast media has been set, the electronic device determines the channel selected by the user and the current time in step 405. Then, the electronic device determines the broadcast output settings of the media being currently broadcast in the channel selected from the storage area 208, and the broadcast ending time of the selected media (that is, the time when the broadcasting of the media ends) in step 407.

Next, the electronic device sets the output settings of the speaker 212 and display 214 that output the broadcast signal according to the determined broadcast output settings in step 409, and changes and outputs the appropriate media broadcast signal received from the communication module 202, according to the output settings for the speaker 212 and display 214 and plays back a selected program, in step 411. For example, if a user selects “Woman Power Hope Korea” that is broadcast on channel A at 00:25 as shown in FIG. 5, the program “Woman Power Hope Korea” is played back with the display 214 set as bright, the resolution set as soft, the sound for the speaker 212 set as clear, and the volume set as moderate.

Then, the electronic device determines, in step 413, whether the broadcast end time of the media that is being played back has been reached or whether the user has changed the broadcast channel. If it is determined the broadcast end time of the media being played back has been reached or the channel has been changed, the electronic device returns to step 405. However, if it is determined that neither the end time has been reached nor the channel has been changed, the electronic device continues to step 415. In step 415, the electronic device determines whether the broadcast viewing/listening mode settings have been cancelled. If it is determined that the broadcast viewing/listening mode settings have not been cancelled, the electronic device returns to step 413. However; if it is determined that the broadcast viewing/listening mode settings have been cancelled, the electronic device ends the algorithm of the present invention.

Although in the above description, the electronic device receives broadcast data including output settings for each media from the broadcast data providing server, the electronic device may have the output setting data for each media type already stored, so that only the data for the media that is broadcast by time and by channel from the broadcast data providing server (for example, media type, title, start time, and end time) is received, and the output settings are altered in accordance with the type of media being broadcast to play back the media.

As described above, an electronic device according to the present invention uses by time and by channel broadcast data to automatically change the output settings for playing back a media being broadcast in accordance with the type of the media, during a digital multimedia broadcast. Thus, even when a user does not manually adjust the playback output settings, optimized output settings for each media are automatically adjusted to play back the media.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of receiving a multimedia broadcast in an electronic device, comprising the steps of:
determining a selected channel and a current time when a broadcast viewing/listening event occurs;
determining an output setting of media corresponding to the channel and the current time; and
playing back the media according to the determined output settings.

2. The method of claim 1, further comprising determining and storing output settings for each type of media using broadcast data received from a broadcast data providing server.

3. The method of claim 2, wherein the received broadcast data comprises at least one of a title, a type, a start time, an end time, and output settings.

4. The method of claim 1, further comprising:
determining whether the selected channel has been changed; and
determining output settings of another media corresponding to the changed channel and the current time when it is determined that the selected channel has been changed;
receiving the another media corresponding to the changed channel using the corresponding determined output settings, when the selected channel has been changed; and
playing back the another media.

5. The method of claim 1, further comprising:
determining whether the media being played back has ended; and
determining output settings of another broadcast media and playing back the another broadcast media according to output settings corresponding to the another media, when it is determined that the media being played back has ended.

6. The method of claim 1, wherein the output settings comprise at least one of sound, volume, screen brightness, and resolution.

7. An apparatus for receiving a digital multimedia broadcast in an electronic device, comprising:
a storage area for storing respective playback output settings for a plurality of media corresponding to time and channel;
a controller for determining a selected channel and a current time and determining output settings of a corresponding media from the storage area, when a broadcast viewing/listening event occurs;
an output setter for setting playback output settings according to the determined output settings; and
an output means for playing back a received broadcast data according to the set playback output settings.

8. The apparatus of claim 7, wherein the output means comprises:
a speaker for outputting a audio signals corresponding to audio information contained the received media; and
a display for outputting image signals corresponding to image information contained in the received media.

9. The apparatus of claim 7, further comprising:
a communication module for receiving broadcast data from a broadcast data providing server; and
a broadcast data analyzer for using the received broadcast data to analyze the respective playback output settings for each of the media, to be stored in the storage area.

10. The apparatus of claim 9, wherein the broadcast data comprises at least one of a title, a type, a start time, an end time, and an output setting of the media.

11. The apparatus of claim 7, wherein the playback output settings comprise at least one of sound, volume, screen brightness, and resolution.

12. A method of receiving a multimedia broadcast in a portable communication terminal, comprising the steps of:
determining a selected channel when a broadcast viewing/listening event occurs;
determining an output setting of media corresponding to the channel; and
playing back the media according to the determined output settings.

13. The method of claim 12, further comprising determining and storing output settings for each type of media using broadcast data received from a broadcast data providing server.

14. The method of claim 13, wherein the received broadcast data comprises at least one of a title, a type, a start time, an end time, and output settings.

15. The method of claim 12, wherein the output settings comprise at least one of sound, volume, screen brightness, and resolution.

16. A portable communication terminal for receiving a digital multimedia broadcast, comprising:
a controller for determining output settings of a corresponding media when a broadcast viewing/listening event occurs;
an output setter for setting playback output settings according to the determined output settings; and
an output means for playing back a received broadcast data according to the set playback output settings.

17. The terminal of claim 16, further comprising
a storage means for storing respective playback output settings for a plurality of media corresponding to the channel wherein the controller determines the output settings in the storage means.

18. The terminal of claim 16, wherein the output means comprises:
at least one of a speaker for outputting a audio signals corresponding to audio information contained the received media and a display for outputting image signals corresponding to image information contained in the received media.

19. The terminal of claim 17, further comprising:
a communication module for receiving broadcast data from a broadcast data providing server; and
a broadcast data analyzer for using the received broadcast data to analyze the respective playback output settings for each of the media, to be stored in the storage area.

20. The terminal of claim 19, wherein the received broadcast data comprises at least one of a title, a type, a start time, an end time, and an output setting of the media.

21. The terminal of claim 16, wherein the playback output settings comprise at least one of sound, volume, screen brightness, and resolution.
